(19) United States
(12) Patent Application Publication
(10) Pub. No.: US 2010/0067422 A1
(43) Pub. Date: Mar. 18, 2010

(54) APPARATUS AND METHODS FOR CONTROLLING A SLEEP MODE IN A WIRELESS DEVICE

(75) Inventors: Tamer A. Kadous, San Diego, CA (US); Michael Kohlmann, San Francisco, CA (US); Alexei Y. Gorokhov, San Diego, CA (US); Jin-Su Ko, San Francisco, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/557,414

(22) Filed: Sep. 10, 2009

Related U.S. Application Data
(60) Provisional application No. 61/096,718, filed on Sep. 12, 2008.

(51) Int. Cl. H04W 52/02; G08C 17/00

(52) U.S. Cl. 370/311; 455/522; 455/574

(57) ABSTRACT

Apparatus and methods for controlling sleep mode in a wireless device are disclosed. The sleep mode is controlled using low power detection of RF beacon signals of known frequencies to reduce power consumption of the wireless device during sleep modes. Detection is achieved by using passive or low power elements in a receive chain that filters received signals allowing beacon signals of particular frequencies to pass, which are accumulated with passive or low power circuit elements requiring no external power source. The accumulated energy is compared to a threshold to determine the presence of the beacon with sleep circuitry. When the beacon is detected, the full RF receiver is triggered to wake up. Use of low power elements and passive elements, affords a beneficial increase in power savings for the wireless device, which is particularly helpful in wireless access points or relay stations that have an alternative power sourcing such as battery or solar power.

### CLAIM OF PRIORITY UNDER 35 U.S.C. §119

The present Application for Patent claims priority to Provisional Application No. 61/096,718 entitled “IDLE MODE OPERATION FOR ACCESS POINTS AND RELAYS” filed Sep. 12, 2008, and assigned to the assignee hereof and hereby expressly incorporated by reference herein.

### REFERENCE TO CO-PENDING APPLICATIONS FOR PATENT

The present Application for Patent is related to the following co-pending U.S. patent applications:

“Apparatus and Methods for Controlling Idle Mode Operation in a Wireless Device” by Gorokhov et al., having Attorney Docket No. 081817, filed concurrently herewith, assigned to the assignee hereof, and expressly incorporated by reference herein

### BACKGROUND

1. Field

The present disclosure relates generally to apparatus and methods for controlling an access point (AP) sleep mode, and more specifically to controlling the AP sleep or idle mode through the use of low power detection of RF signals of known frequencies in order to reduce power consumption for control of idle or sleep modes in an AP or Relay station (RS).

2. Background

New wireless communication deployment models are currently emerging where coverage and high capacity is enabled via dense networks of low-cost nodes. These nodes may be either wired access points (APs) or wireless relay stations (RS). Cost efficiency of such deployments is achieved not only due to low device cost but, more importantly, due to reduction in the costs of site acquisition, rental and maintenance. In this context, enabling cordless or non-wired RSs with an alternative source of power, such as through using a solar power source, has been proved efficient in some deployment scenarios. Alternatively, deploying an AP without an alternative power supply which is otherwise required to ensure robustness to power outages also yields a substantial reduction in the deployment cost. In both cases, the ability of an AP or RS to substantially reduce its power consumption during inactivity or idle periods is desirable.

It is noted that for access terminals (ATs) such as handsets or other portable devices, various forms of power save operations are well known in wireless standards to improve battery life of user equipment or access terminal (AT). In wireless cellular systems, for example, typical forms of AT power save operation are “idle mode” and various forms of active “sleep mode.” Further, the concept of power efficient operation for network node type devices is also known, such as in the case of network nodes in IEEE Std. 802.11 that are enabled to provide power efficient forwarding in a mesh Wi-Fi network or micro cellular environment. The application of operations such as idle or sleep modes to APs or RSs (and even ATs) in a mesh or microcell network would be desirable to reduce power consumption during inactivity periods. Notwithstanding, sensing of RF network activity used to trigger awakening of sleeping devices in a network typically utilizes active devices in the receive chain to sense the RF signals (e.g., RF receiver blocks, amplifiers, Automatic Gain Control (AGC), etc). Although the hardware of such receive chains can be configured to operate at lower power, the power consumption of such devices can still be significant. Accordingly, it would be desirable to provide a further reduction in power consumption of components used to detect network activity to conserve power resources, as well as reduce costs of the AP or RS equipment.

### SUMMARY

According to an aspect, an apparatus for controlling a sleep mode in a wireless device is disclosed. The apparatus includes at least one bandpass filtering unit comprising at least one of passive and low power elements and configured to allow at least one beacon signal of one or more frequencies to pass. The apparatus further includes at least one accumulator unit configured to store energy from signals passed by the bandpass filtering unit, the accumulator unit comprising at least one of passive and low power elements. A comparator operable in a low power portion of the wireless device is configured to compare the level of stored energy in the accumulator to a predetermined threshold. Finally, the apparatus includes a sleep controller operable in the low power portion of the wireless device and configured to issue a wakeup trigger signal to other circuitry in the wireless device when the level of stored energy in the accumulator exceeds the predetermined threshold.

In another aspect, a method for controlling a sleep mode in a wireless device is disclosed. The method includes bandpass filtering wireless signals to derive at least one RF narrowband beacon signal using at least one of passive and low power filter elements. Next, the method includes accumulating energy of the at least one RF narrowband beacon signal using at least one of passive and low power elements, and comparing the accumulated energy with a predetermined threshold. The presence of the at least one RF narrowband beacon signal is then determined when the accumulated energy is greater than the predetermined threshold; and signaling wakeup of wireless device circuitry based on determination of the presence of the at least one RF narrowband beacon signal.

In still one further aspect, an apparatus for controlling a sleep mode in a wireless device is disclosed. The apparatus includes means for bandpass filtering wireless signals to derive at least one RF narrowband beacon signal using passive or low power filter elements, and means for accumulating energy of the at least one RF narrowband beacon signal also using one or more passive or low power elements. Furthermore, the apparatus includes means for comparing the accumulated energy with a predetermined threshold, and means for determining the presence of the at least one RF narrowband beacon signal when the accumulated energy is greater than the predetermined threshold; and means for signaling wakeup of wireless device circuitry based on determination of the presence of the at least one RF narrowband beacon signal.

### BRIEF DESCRIPTION OF THE DRAWINGS

FIG. 1 is a diagram of an exemplary wireless network in which the disclosed apparatus and methods may be utilized.

FIG. 2 is a block diagram of an exemplary apparatus for use in a wireless device to sense a particular wireless signal from another network device in order to control the idle or sleep mode of the wireless device.

FIG. 3 is a block diagram of an alternative arrangement of the apparatus of FIG. 2 where multiple sensing receive chains are utilized to simultaneously detect multiple signals of different frequencies.

FIG. 4 is a block diagram of another exemplary apparatus for use in a wireless device to sense a particular wireless signal from another network device in order to control the idle or sleep mode of the wireless device.

FIG. 5 is a flow diagram of a method for sensing a particular wireless signal from another network device in order to control the idle or sleep mode of the wireless device.

### DETAILED DESCRIPTION

The present disclosure describes apparatus and methods for controlling an access point (AP) idle mode by using low power detection of RF signals of known frequencies in order to reduce power consumption in idle or sleep modes in a wireless device, such as an AP or Relay station (RS), as well as an AT. In an aspect, a low power RF receive chain may be implemented using one or more passive elements that do not require a power source for reception and accumulation of signal energy of a particular tone or frequency (e.g., a narrowband signal). According to one example, the particular signal may be a beacon signal having a pre-specified frequency and transmitted by an AT to indicate its presence within a network. The presence of the particular signal, such as a beacon signal, may then be detected during an idle or sleep mode when signal energy is accumulated such that a threshold is exceeded, which in turn may be used to initiate wake up of the full RF receiver and modem in the wireless device. By utilizing passive elements rather than powered active elements for even a portion of signal detection during idle mode, a power savings is realized.

The techniques described herein may be used for various wireless communication networks including cellular networks with microcells or 3G micro-networks. The networks may be configured as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16 (WiMax), IEEE 802.20, Flash-OFDM , etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). The techniques described herein may also be applied in future technologies such as International Mobile Telecommunications-Advanced (IMT Advanced), better known as 4G, or any other technology present or future that may employ mesh networks, microcell or micro networks, femtocell networks, picocell networks, peer-to-peer, or other similar schemes.

Although the terminology used herein to describe the disclosed methods and apparatus refers to access points (APs) and relay stations (RSs), these terms are understood to include base station, NodeB, evolved Node B (eNodeB or eNB)), repeaters, or equivalent devices. Further, the term access terminal (AT) as used herein is understood to encompass devices described by terms such as User Equipment (UE), mobile device, terminal, wireless communication device, Subscriber Station (SS), or other equivalent terminology.

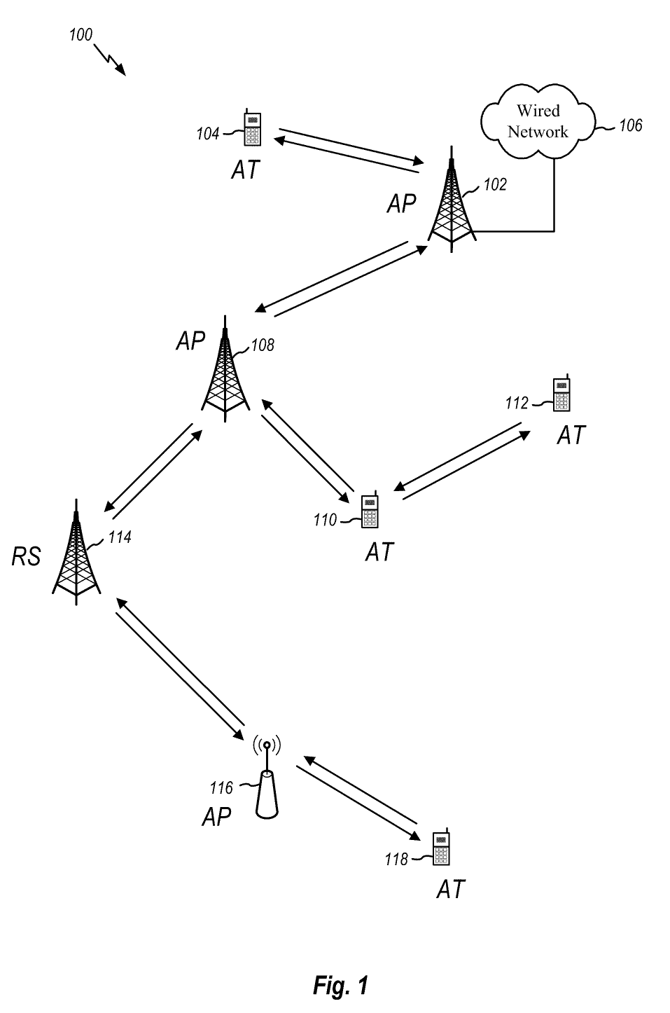

FIG.1 illustrates one example of a network architecture in which the present apparatus and methods may be utilized. The network 100 may be a mesh type network, microcell or micro network, femtocell network, picocell network, Wi-Fi, or a heterogeneous network of a combination of different types of nodes or APs. Network 100 may include an AP 102 that provides network service for ATs, such as AT 104. Additionally, AP 102 is shown connected to a wired network 106 (and may also be wired to a normal source of power).

AP 102 is further illustrated wirelessly networked with another AP 108, which may be not wired to a normal source of power. AP 108 provides network service to an AT 110. As an example of peer-to-peer communication, AT 110 is shown in communication with another AT 112. In an aspect, the presently disclosed apparatus and methods could be implemented in an AT, such as AT 110, in detecting a beacon from another AT, such as AT 112.

FIG. 1 also illustrates a relay station RS 114, which is in communication with AP 108. RS 114 may effect relaying or repeating of wireless communications from one AP (e.g., AP 108) to one or more other APs, such as AP 116. AP 116 provides network service to one or more ATs, such as AT 118.

It is noted that the APs illustrated in FIG. 1 may be configured to broadcast one or more beacons or other similar identifying signals at known one or more predetermined frequencies or tones. In turn, when an AP detects the beacon, communication between the AP and AT may initiate to allow network access to the AT, for example. If the AP utilizes a sleep or idle mode where power consumption is reduced during idle periods or periodically, the AP will need to turn on at least a portion of the RF receive chain to detect the presence of AT beacon signals. If the RF receive chain is utilizing active components, the power usage will be higher than passive components, for example. Accordingly, the present apparatus and methods utilize one or more passive elements requiring no power source other than the energy of the received beacon(s).

It is noted that the transmission of beacon signals is not limited to ATs, but could also be transmitted by APs or RSs, especially for mobile APs and RSs that need to registered or discovered when placed. Also, ATs may employ beacon detection, such as in the case of peer-to-peer communications as illustrated by ATs 110 and 112 in FIG. 1.

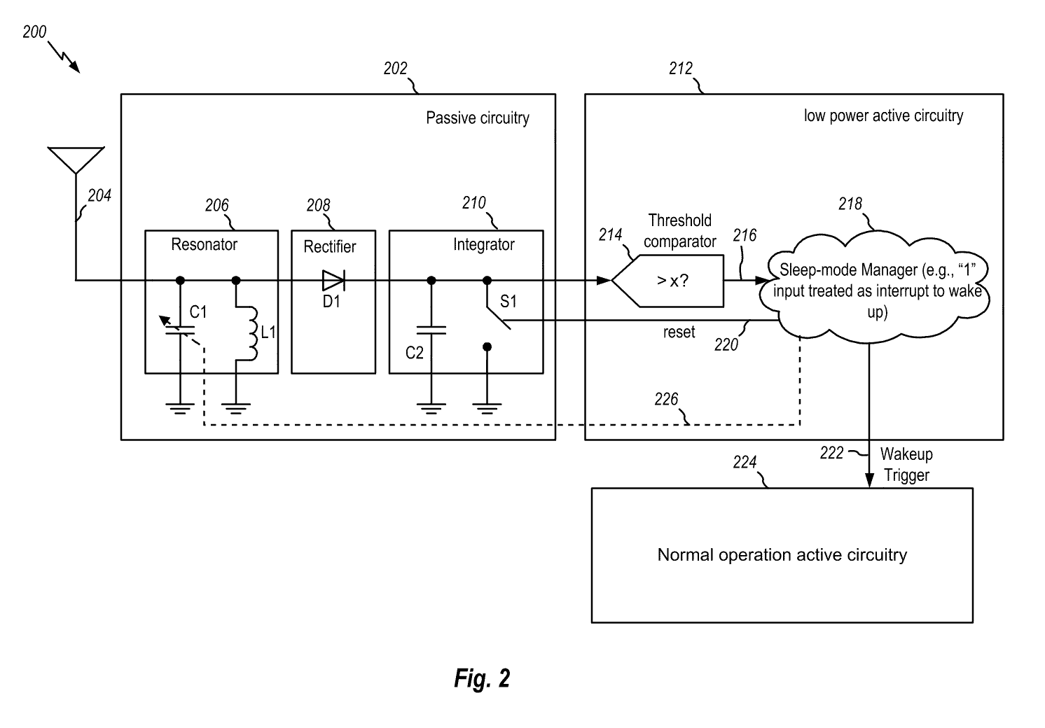

FIG. 2 is a block diagram of an exemplary apparatus 200 for use in a wireless device to sense a particular wireless signal (i.e., the beacon(s)) from another network device in order to control the idle or sleep mode of the wireless device. As mentioned above, the wireless device may be an AP, RS or and AT.

A detection portion of apparatus 200 can be fully or at least partially implemented by passive elements that detect a particular energy level of the signal at a particular narrowband frequency response. Thus, in an aspect a narrowband or bandpass filter of the signal will pass through energy to a means to accumulate the energy. If the energy accumulated reaches a threshold amount, this indicates the likelihood that the particular signal of interest is present. Accordingly, the example of FIG. 2 illustrates a passive circuitry portion 202 consisting of solely passive circuit elements, which are used to filter and accumulate energy of those signals of a particular frequency passing through the filtering.

Circuitry portion 202 is connected to an antenna to receive RF signals present in the vicinity. The narrowband response or bandpass filtering can be implemented, in one example, by a bandpass filter unit 206. In an aspect, unit 206 may be implemented with a passive resonator circuit 206. Resonator 206 allows energy of signals at a particular narrowband frequency to pass, while blocking energy from signals of other frequencies. In the illustrated example, the resonator 206 may consist of simply a parallel arrangement of a capacitor (C1) and inductor (L1) having values set to cause resonance in the C1 and L1 elements at a desired frequency. It is noted that more complex arrangements, such as an LC series resonant circuit, or a combination of LC series and parallel elements, are also contemplated dependent on desired additional features such as noise filtering.

The passive circuitry 202 may also include a rectifier 208 to convert the alternating, zero-mean signal passed through by resonator 206 into a rectified, non-zero mean signal. In the example of FIG. 2, rectifier 208 could be implemented as simply as a half-wave rectifier using a diode D1, but more complex arrangements, such as full wave rectification or a gate controlled diode are contemplated.

The rectified signal is passed to an integrator or accumulator 210 that is configured to accumulate the signal over a predefined time. The integrator 210 may be implemented by a capacitor C2 having a predetermined value to effect a suitable charging constant. Other known devices for accumulating charge or energy known to those skilled in the art may also be used in lieu of capacitor C2. Integrator 210 may also include a switch Si that serves to discharge capacitor C2, either in the event that a predetermined threshold charge has been accumulated or to discharge partial charge on the capacitor when the predefined time has lapsed.

If the integrator is implemented with a capacitor to accumulate charge, as shown in the example of FIG. 2, a DC or non-zero mean current is needed to cause charging of the capacitor C2. Thus, if other types of charge accumulation devices are used, it could be conceivable other circuit elements are needed. Thus, for purposes of this application, the combination of rectifier 208 and integrator 210 may be collectively considered an “accumulator” and other arrangements for effecting charge accumulation besides the rectifier 208 and integrator 210 are contemplated.

The voltage on capacitor C2 is input to low power active circuitry 212 for comparison with a predetermined threshold. It is noted that circuitry 212 may be low power circuitry used in an AP, RS, or AT to perform necessary monitoring, clocking, and other functions that need to occur during a sleep mode of the wireless device. Circuitry 212 includes a threshold comparator 214 to compare the voltage output from integrator 210 to a predetermined threshold (x). If the level is above the threshold, the comparator output state 216 changes (e.g., from a “0” to “1” state), which indicates that the beacon or desired signal is present. In certain situations, the beacon signal(s) could penetrate to multiple APs. Accordingly, there is a potential that more than one AP would detect the beacon and subsequently be woken up and even transmit a preamble (i.e., a signal enabling discovery of the AP) to the AT, thus leading to some loss in sleep time and unnecessary power consumption. Such false detections may be mitigated by proper adjustment of the predetermined threshold of comparator 214 such that only the closest AP(s) wakes up.

The output state 216 is input to circuitry or an algorithm run on a processor configured for sleep mode management (represented by cloud to indicate a sleep-mode manager or “sleep controller” 218 that can be hardware, firmware, software, or a combination thereof). The sleep controller 218 is configured to recognize a particular output state (e.g., “1”) from the comparator 214 as detection of the beacon signal. In response, sleep controller 218 may, in turn, issue a wakeup trigger 222 to initiate full wakeup of normal operation active circuitry 224. Circuitry 224, which operates at higher power for RF signal reception and signal processing, is normally put to sleep either periodically or responsive to the lack of network activity to save power.

The sleep controller 218 may also be configured to issue a reset signal 220 to reset the integrator 210 either after detection of the beacon signal or after the predefined time period. In the particular example illustrated in FIG. 2, the signal 220 operates a reset device, such as a switch 51 that is closed momentarily to discharge capacitor C2. It is noted that for the example in FIG. 2, the reset device may be implemented by any number of known switching devices such as a transistor, a thyristor, solid state relay, or any other suitable switching device. It will be appreciated that lower power switching devices are more beneficial in terms of power savings.

The beacon signals detected by circuitry 202 and 212 may be a predetermined singular frequency. Alternatively, multiple predetermined tones or frequencies may be used effect beacon in a network. In such case, the passive circuitry 202 may need to detect multiple narrowband beacon signals. Accordingly, FIG. 2 illustrates an alternative example where the resonator 202 may be variable to “tune” to various different frequencies. As one example, capacitor C1 may be a variable device to vary the resonant frequency of the C1, L1 combination. It is noted that capacitor C1 may be a mechanically variable capacitor, or low power devices such as a MEMS capacitor or a digital capacitor. It is also contemplated (although not shown) that L1 could be a variable digital inductor.

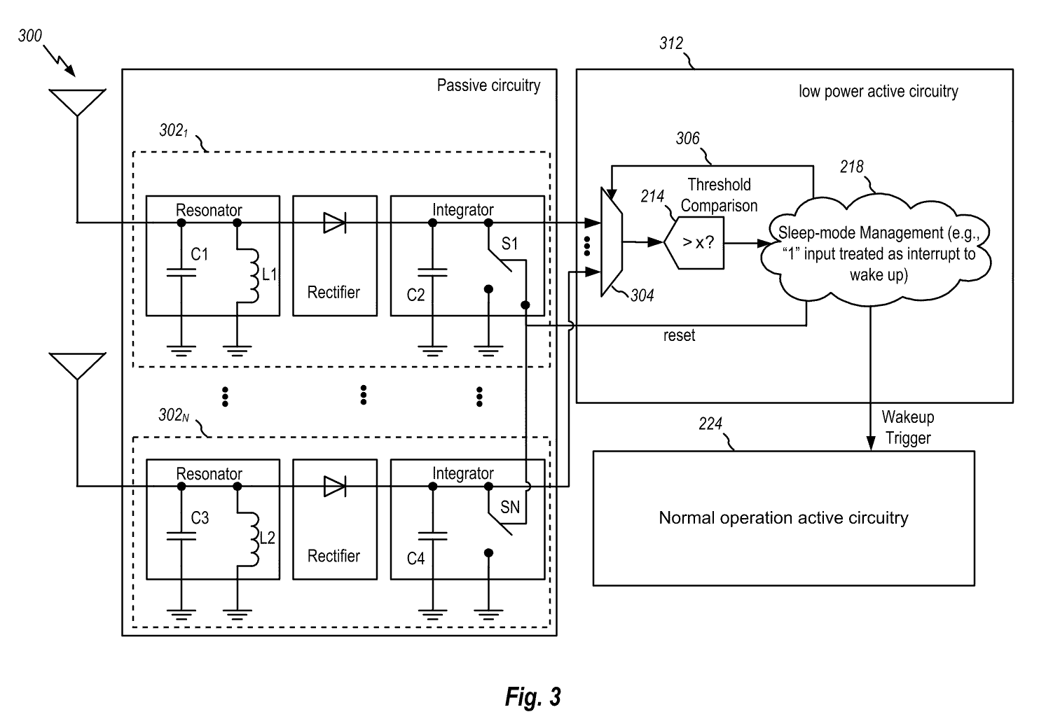

In still another alternative, FIG. 3 illustrates a modification 300 of apparatus 200 where multiple passive receive chain circuits (3021 through 302N) may be utilized for an N number of beacons each having a different tone (note: elements unchanged from apparatus 200 use the same reference numbers as FIG. 2). Each receive chain 302 is tuned to a distinct frequency corresponding to the respective tone of the beacons. The outputs 304 of the receive chains 302 may then be input to a multiplexer 306 or similar device in to low power active circuitry 308 to select between the inputs from receive chains to compare with the threshold by comparator 214. It is also contemplated that rather than a multiplexer, multiple comparators could be used (not shown), each comparator coupled to a respective one of the receive chains 302.

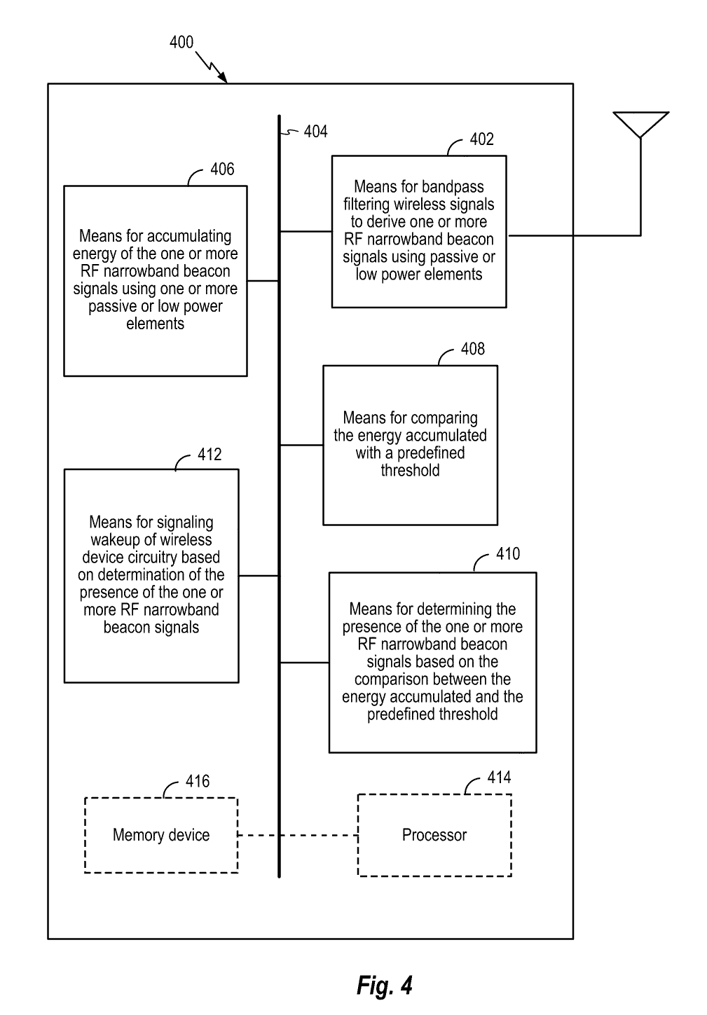

FIG. 4 illustrates another apparatus 400 that may be used in a wireless device, such as an AP, to detect one or more beacon signals of particular tones. Apparatus 400 includes a means 402 for bandpass filtering wireless signals derived from an antenna to derive one or more RF narrowband beacon signals using one or more of passive or low power elements. In an aspect, the low power elements may be passive circuitry consisting of different arrangements of capacitive and inductive elements, such as in the example of resonator 206 in FIG. 2. Means 402 may also be implemented with a combination of lower power elements such as passive elements (e.g., capacitors and inductors) and active elements (which may also be low power elements such as MEMs capacitors and digital capacitors and inductors).

Apparatus 400 is further illustrated with a bus 404 for coupling the different means or modules and represent means for communication of signals, voltages, currents, etc. Means 402 may pass the RF signals of the particular narrowband tones or frequencies via bus 404 to a means for 406 for accumulating energy of the one or more bandpass filtered narrowband signals using one or more passive or low power elements. Means 406 may, in one aspect, be implemented with a rectifier (e.g., 208) and an integrator (e.g., 210) comprising a capacitor (e.g., C2 in FIG. 2). Other suitable equivalent means for accumulating charge may also be utilized instead of a capacitor.

The energy level of means 406 is then sensed by a means 408 for comparing the energy accumulated with a predefined threshold (e.g., the voltage accumulated is compared to a voltage threshold). Means 408 may implemented in one example by comparator 214. Furthermore, means 408 may be implemented within low power or sleep circuitry portion of a wireless device, such as circuitry 212 in FIG. 2.

The output of means 408 may be communicated to a means 410 for determining the presence of the one or more RF narrowband beacon signals based on the comparison between the energy accumulated and the predefined threshold. In an example, if the state of the output of means 408 changes (e.g., from a “0” to a “1”), which indicates that the threshold is exceeded, then means 410 will make a determination that at least one particular narrowband beacon signal is present. As an example, means 410 may be implemented as the sleep controller 218 shown in FIG. 2. Additionally, in an aspect, means 410 may be implemented within a low power or sleep circuitry portion of a wireless device, such as circuitry 212 in FIG. 2. Means 410 may also implement a timer to keep track of a predefined time period in which sensing occurs and effect sending a reset to the accumulation means 406 (which may include a means for reset, such as a switch (e.g., S1)) either after the time period has elapsed or after detection of a beacon.

When means 410 makes a determination of the presence of the at least one narrowband RF beacon signal, a means 412 for signaling wakeup of wireless device circuitry make issue a wakeup signal to other circuitry (e.g., normal operation circuitry 224).

It is noted that means 410 and 412 may be implemented by software, hardware, firmware, or any combination thereof. Software implementation may be effected through a processor (illustrated by block 414) executing stored code or instructions stored in a memory (e.g., memory 416).

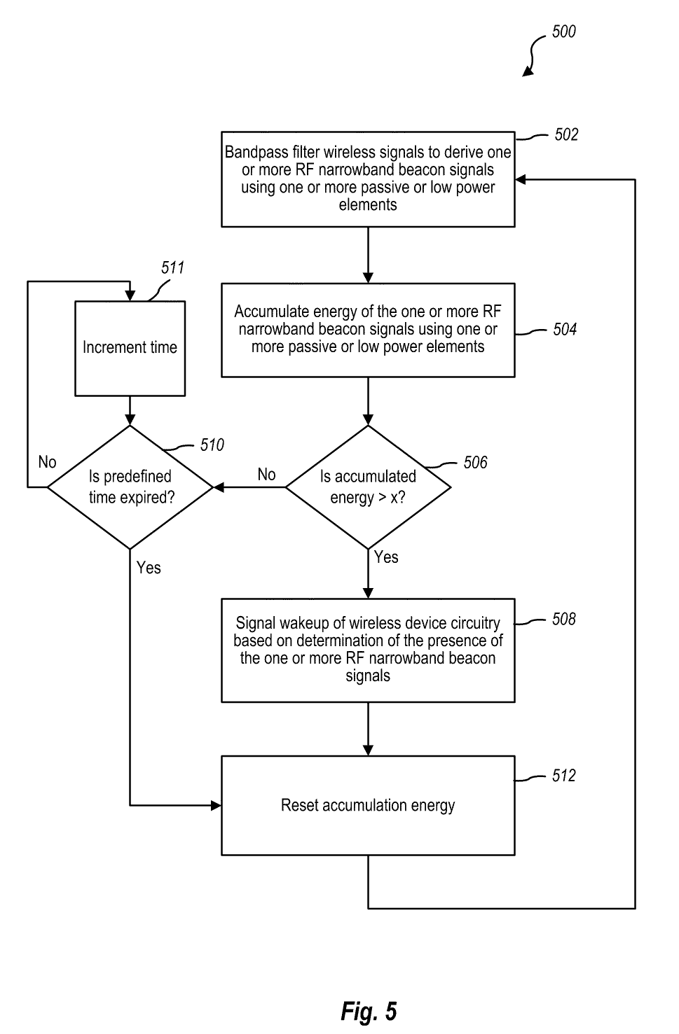

FIG. 5 illustrates an exemplary method 500 for control of a sleep mode in a wireless device that utilizes low power or passive components in its execution. As shown in block 502, method 500 includes bandpass filtering received wireless signals to derive one or more RF narrowband beacon signals using one or more passive or low power elements. As discussed before, bandpass filtering may be performed by low power elements such as a resonator having all passive elements (capacitors and inductors), which require no power except the RF signals, or low power digital capacitors, digital inductors, or MEMs capacitors, which still provide elements utilizing less or low power than normal RF receive chain elements.

The method further includes a process in block 504 where energy of the one or more bandpass filtered narrowband signals derived from the filtering processes of block 504 is accumulated using one or more passive or low power elements. As an example, the energy may be accumulated with an integrator comprising passive elements; namely a rectifier (e.g., diode D1) to provide a non-zero mean signal from the narrowband beacon signal(s) and a capacitor (e.g., C2) that accumulates the charge from the rectified signal(s).

As the energy is accumulated in the process of block 506, a comparison of the voltage or energy level in the integrator to a predetermined threshold is continuously performed (or, alternatively, performed periodically) as indicated by decision block 508 illustrating the check of a condition whether the accumulated energy is greater than predetermined threshold x. If the threshold has been exceeded, this means that a beacon is detected and flow proceeds from block 508 to signal wakeup of wireless device circuitry (e.g., 224) based on determination of the presence of the one or more RF narrowband beacon signals 508

If the condition of block 506 is not yet met, flow proceeds to decision block 510 where a check is made whether a predefined time period has been exceeded. If not, the flow is shown proceeding to a block 511 for incrementing the time and looping back to block 510. Although not shown, it would be evident to one skilled in the art that a time increment count is reset when the predefined time has been reached. It is also noted that the processes blocks 502 and block 504 are continually performed since the passive circuit elements simply respond to certain RF frequencies received, and the charge accumulated would be reset upon either a detection of a beacon or exceeding the predefined time, whichever comes first. This is illustrated by flow from either block 510 or 508 to block 512 where the accumulation is reset (e.g., S1 is operated discharging capacitor C1 assuming the example of FIG. 2).

It is noted that for the alternative arrangements illustrated in FIGS. 2 and 3 where different frequencies for beacons of multiple or different tones, one skilled in the art will appreciate that method 500 may be modified to account for the detection of multiple tones. For example, the processes of blocks 502, 504, and 506 may be repeated for each method 500 may be executed for each receive chain 302 in the example of FIG. 3 and block 506 may further include cycling through each receive chain 302 with multiplexer 304 and detection made when one or more of the receive chains 302 yields a voltage exceeding the predetermined threshold. Similarly, in the case of a variable capacitor to tune the resonator 206, the process of blocks 502, 504, 506 may account for each “tuning” of resonator and signal detection when one or more of the different tunings results in an accumulator level exceed the predetermined threshold.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill will further appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In one example herein, the comparator 214 and sleep manager 218 may be implemented with code stored on a computer readable medium.

It is noted that in the above discussion, the word “element” is intended to refer to circuitry components, such as a capacitors or inductors as merely two examples. The word “exemplary” is used herein to mean “serving as an example, instance, or illustration.” Any example described herein as “exemplary” is not necessarily to be construed as preferred or advantageous over other examples.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. An apparatus for controlling a sleep mode in a wireless device, the apparatus comprising:
at least one bandpass filtering unit comprising at least one of passive and low power elements and configured to allow at least one beacon signal of one or more frequencies to pass;
at least one accumulator unit configured to store energy from signals passed by the bandpass filtering unit, the accumulator unit comprising at least one of passive and low power elements;
a comparator operable in a low power portion of the wireless device and configured to compare the level of stored energy in the accumulator to a predetermined threshold; and
a sleep controller operable in the low power portion of the wireless device and configured to issue a wakeup trigger signal to other circuitry in the wireless device when the level of stored energy in the accumulator exceeds the predetermined threshold.

2. The apparatus as defined in claim 1, wherein the at least one of passive and low power elements of the filtering unit comprise a resonator circuit including at least one capacitor and at least one inductor wherein values of the at least one capacitor and at least one inductor are set such that the resonator circuit resonates at a resonant frequency matching the frequency of the at least one beacon signal.

3. The apparatus as defined in claim 2, wherein the resonator circuit comprises at least one of a parallel LC circuit and a series LC circuit.

4. The apparatus as defined in claim 2, wherein the at least one capacitor comprises a variable capacitor controllable by the sleep manager to vary the resonant frequency.

5. The apparatus as defined in claim 1, wherein the accumulator unit comprises at least one capacitor and a rectifier.

6. The apparatus as defined in claim 5, wherein the accumulator circuit further comprises a reset device configured to discharge the capacitor responsive to a reset signal from the sleep controller.

7. The apparatus as defined in clam 1, wherein the at least one passive and low power elements is configured to operate during a sleep mode of the wireless device at a power level lower than a normal power level of the wireless device circuitry operating in a normal mode.

8. The apparatus as defined in claim 1, wherein the wireless device comprises one of an access point, an access terminal, and a relay station.

9. A method for controlling a sleep mode in a wireless device, the method comprising:
bandpass filtering wireless signals to derive at least one RF narrowband beacon signal using at least one of passive and low power filter elements;
accumulating energy of the at least one RF narrowband beacon signal using at least one of passive and low power elements;
comparing the accumulated energy with a predetermined threshold;
determining the presence of the at least one RF narrowband beacon signal when the accumulated energy is greater than the predetermined threshold; and
signaling wakeup of wireless device circuitry based on determination of the presence of the at least one RF narrowband beacon signal.

10. The method as defined in claim 9, further comprising:
comparing the accumulated energy with the predetermined threshold for a predefined time period; and
resetting the accumulated energy if the accumulated energy does not exceed the predetermined threshold within the predefined time period.

11. The method as defined in claim 9, wherein the at least one of passive and low power filter elements comprise a resonator circuit including at least one capacitor and at least one inductor wherein values of the at least one capacitor and at least one inductor are set such that the resonator circuit resonates at a resonant frequency matching the frequency of the at least one beacon signal.

12. The method as defined in claim 11, wherein the resonator circuit comprises at least one of a parallel LC circuit and a series LC circuit.

13. The method as defined in claim 11, further comprising:
varying the capacitance of the at least one capacitor to vary the resonant frequency over a plurality of frequencies; and
comparing the accumulated energy with the predetermined threshold for each of the plurality of frequencies.

14. The method as defined in claim 9, further comprising:
rectifying the at least one RF narrowband beacon signal prior in order to accumulate the energy of the at least one RF narrowband beacon signal with a capacitor from the at least one of passive and low power elements.

15. The method as defined in claim 14, further comprising:
resetting the capacitor through discharge of the capacitor charge in response to a reset signal from a sleep controller operable in a low power sleep portion of the wireless device.

16. The method as defined in clam 9, further comprising:
signaling wakeup of wireless device circuitry based on determination of the presence of the at least one RF narrowband beacon signal with low power sleep circuitry during a sleep mode of the wireless device.

17. The method as defined in claim 9, wherein the wireless device comprises one of an access point, an access terminal, and a relay station.

18. An apparatus for controlling a sleep mode in a wireless device, the apparatus comprising:
means for bandpass filtering wireless signals to derive at least one RF narrowband beacon signal using at least one of passive and low power filter elements;
means for accumulating energy of the at least one RF narrowband beacon signal using at least one of passive and low power elements;
means for comparing the accumulated energy with a predetermined threshold;
means for determining the presence of the at least one RF narrowband beacon signal when the accumulated energy is greater than the predetermined threshold; and
means for signaling wakeup of wireless device circuitry based on determination of the presence of the at least one RF narrowband beacon signal.

19. The apparatus as defined in claim 18, further comprising:
means for comparing the accumulated energy with the predetermined threshold includes means for determining the elapse of a predefined time period; and
means for resetting the accumulated energy if the accumulated energy does not exceed the predetermined threshold within the predefined time period as determined by the means for determining the elapse of the predefined time period.

20. The apparatus as defined in claim 18, wherein the at least one of passive and low power filter elements comprise a resonator circuit including at least one capacitor and at least one inductor wherein values of the at least one capacitor and at least one inductor are set such that the resonator circuit resonates at a resonant frequency matching the frequency of the at least one beacon signal.

21. The apparatus as defined in claim 20, wherein the resonator circuit comprises at least one of a parallel LC circuit and a series LC circuit.

22. The apparatus as defined in claim 20, further comprising:
means for varying the capacitance of the at least one capacitor to vary the resonant frequency over a plurality of frequencies; and
means for comparing the accumulated energy with the predetermined threshold for each of the plurality of frequencies.

23. The apparatus as defined in claim 18, further comprising:
means for rectifying the at least one RF narrowband beacon signal prior in order to accumulate the energy of the at least one RF narrowband beacon signal with a capacitor from the at least one of passive and low power elements.

24. The apparatus as defined in claim 23, further comprising:
means for resetting the capacitor through discharge of the capacitor charge in response to a reset signal from a sleep controller operable in a low power sleep portion of the wireless device.

25. The apparatus as defined in clam 18, further comprising:
means for signaling wakeup of wireless device circuitry based on determination of the presence of the at least one RF narrowband beacon signal with low power sleep circuitry during a sleep mode of the wireless device.

26. The apparatus as defined in claim 18, wherein the wireless device comprises one of an access point, an access terminal, and a relay station.

27. A computer program product, comprising:
computer-readable medium comprising:
code for causing a computer to compare an accumulated energy with a predetermined threshold, wherein the accumulated energy is derived from an apparatus configured to bandpass filter wireless signals to derive at least one RF narrowband beacon signal using at least one of passive and low power filter elements and accumulate energy of the at least one RF narrowband beacon signal using at least one of passive and low power elements;
code for causing a computer to determine the presence of the at least one RF narrowband beacon signal when the accumulated energy is greater than the predetermined threshold; and
code for causing a computer to signal wakeup of wireless device circuitry based on determination of the presence of the at least one RF narrowband beacon signal.
